(19) United States
(12) Patent Application Publication
(10) Pub. No.: US 2013/0098537 A1
(43) Pub. Date: Apr. 25, 2013

(54) GREEN TIRE FORMING METHOD AND PNEUMATIC TIRE PRODUCING METHOD

(71) Applicants: Kiyoto Maruoka, Kobe-shi (JP); Hiroyuki Onimatsu, Kobe-shi (JP)

(72) Inventors: Kiyoto Maruoka, Kobe-shi (JP); Hiroyuki Onimatsu, Kobe-shi (JP)

(73) Assignee: SUMITOMO RUBBER INDUSTRIES, LTD., Kobe-shi, Hyogo (JP)

(21) Appl. No.: 13/807,813

(22) PCT Filed: Mar. 23, 2011
(86) PCT No.: PCT/JP2011/056945

§ 371 Date: Dec. 31, 2012

(30) Foreign Application Priority Data
Jul. 9, 2010 (JP) 2010-157065

(51) Int. Cl. B29D 30/20

(52) U.S. Cl. CPC B29D 30/20
USPC 156/117; 156/131

(57) ABSTRACT

A method includes a tubular carcass with core forming process (K1), a rubber laminate forming process (K2), and a tubular base tire forming process (K4). The forming process (K1) of forming a tubular carcass with bead core (6R3) on a first drum (20) comprises a tubular carcass forming step (K1a) to form a tubular carcass (6R2) by butt-jointing circumferential end faces of a carcass ply member (6R1) wound singly on the first drum (20), and a bead core joining step (K1b) to form integrally by diameter-expanding and pressing the tubular carcass (6R2) against the bead cores (5) outserted on the radially outer side. In the forming process (K2), rubber members for base tire (Ga) including an inner liner rubber member (G10a) are wound on a second drum (27) so as to form a rubber laminate (11). In the forming process (K4), the tubular carcass with bead core (6R3) is transferred from the first drum (20) to the second drum (27), and the rubber laminate 11 is pressed against the tubular carcass with bead cores (6R3) so as to form a tubular base tire (35).

### TECHNICAL FIELD

The present invention relates to a green tire forming method and a pneumatic tire producing method being capable of forming efficiently the green tire with a butt-jointed carcass ply.

### BACKGROUND OF THE INVENTION

With regard to form a green tire (unvulcanized tire), to wrap a single layer of a sheet-like carcass ply member for forming the carcass ply around an outer periphery of a cylindrical drum, and both circumferential end portions of the sheet-like carcass ply member are jointed each other.

As known examples of this jointing method, there are an overwrap joint J1 where both circumferential end portions (ae) of a carcass ply member (a) are overwrapped each other to joint as shown in FIG. 9(A), and a butt-joint 32 (see Patent Document 1) where by use of a joint apparatus with a pair of conical bodies (b), the both end surfaces (ae1) of end potions (ae) are jointed by confronting each other as shown in FIG. 9(B).

The butt-joint J2 does not make any overwrap part (f) between the end portions (ae) such as the overwrap joint J1, and there is not any unevenness of thickness nor of rigidity caused by the overwrap potion. It has therefore an advantage of improving the tire uniformity and the appearance. However, there are problems that the confronting force between the end surfaces (ae1) is weak, and it has insufficient joint strength. Recent years, to enhance the joint strength, a method was proposed as shown in FIG. 10, that a pair of conical bodies (b) were arranged over-and-under (inward-and-outward in the drum radial direction), and pull the end portions (ae) from the both sides of the carcass ply member (a) so as to joint them (See Patent Document 2).

However, while forming the green tire, an inner liner rubber member for forming the inner liner rubber is wound on the drum before forming the carcass ply member. Therefore, a new problem arises that this inner liner rubber member interferes in butt-jointing the carcass ply member (a) from the both over-and-under sides.

### STATE OF ART REFERENCE

### Patent Document

Patent Document 1: Japanese unexamined Patent Application Publication No. 2005-153349.
Patent Document 2: Japanese unexamined Patent Application Publication No. 2007-320196.

### SUMMARY OF THE INVENTION

### Problems to be Solved by the Invention

It is an object of the present invention to provide the green tire forming method and the pneumatic tire producing method being capable of forming the green tire having an improved joint strength of the joint portion with efficiency and high accuracy.

### Means for Solving the Problem

To solve the above-mentioned problem, the present invention of claim 1 is characterized in that

a green tire forming method comprises:

a tubular carcass with bead cores forming process to form a tubular carcass with bead cores on a first drum, which comprises
a tubular carcass forming step comprising
winding a sheet-like carcass ply member on an outer periphery of the first drum in a single layer, and
butt-jointing each circumferential end face of the carcass ply member each other, and
a bead core joining step comprising
putting a pair of bead cores on radially outwardly and axially both end sides of the tubular carcass on the first drum,
expanding a diameter of the first drum with the tubular carcass so that the tubular carcass is pressed against an inner periphery of bead cores and is firmly jointed thereto;

a rubber laminate forming process to form a cylindrical rubber laminate having a smaller outside diameter than an inside diameter of the tubular carcass by winding rubber members for a base tire including an inner liner rubber member on an outer periphery of a second drum which is expandable in a diameter;

a first transport process to transport the tubular carcass with bead cores from the first drum to the second drum by use of a transfer, and to maintain concentrically the tubular carcass with bead cores radially-outside the rubber laminate on the second drum;

a tubular base tire forming process by expanding the outside diameter of the second drum with the rubber laminate so that the rubber laminate is pressed against the inner periphery of the tubular carcass with bead cores so as to form a tubular base tire formed by jointing integrally the rubber laminate with the tubular carcass with bead cores; and

a second transport process to transport the tubular base tire from the second drum to a shaping drum by use of a transfer.

The pneumatic tire producing method of the present invention is characterized in that the green tire obtained in the above-mentioned green tire forming method is vulcanized after shaping.

In the present description, the “base tire” means a green (unvulcanized) tire body i n which a tread portion has not been formed. The green tire is formed by jointing an annular tread ring, which is made of a belt ply member for forming a belt layer and of a tread rubber member for forming a tread rubber, for example, with this base tire.

The present invention is made with the two drums as above stated. In the first drum, the tubular carcass with bead cores is formed by winding the single layer of the carcass ply member, butt-jointing the circumferential both end faces, and disposing the bead cores outwardly in the radial direction. In the second drum, the rubber laminate is formed by winding the base tire rubber member comprising the inner liner rubber member.

In this way, the carcass ply member is wound on the different drum from that of the inner liner rubber member, and the inner liner rubber member does not interfere with it; and the both circumferential end faces of the carcass ply member can be butt-jointed from the both over-and-under sides. The joint strength of the joint portion can be sufficiently enhanced.

In the present invention, by use of the transfer, the tubular carcass with bead cores received from the first drum maintains concentrically outwardly in the radial direction of the rubber laminate on the second drum. Moreover, in this state, the second drum is expanded in a diameter, and the rubber laminate is pressed against the inner periphery of the tubular carcass with bead cores so as to integrate them. Therefore, without using any complicated apparatus, the above-mentioned rubber laminate and the tubular carcass with bead cores, which are formed separately, can be jointed easily with high accuracy and efficiency. Furthermore, since the above-mentioned jointing is performed by the diameter-expanding of the rubber laminate, the diameter of the tubular carcass with bead cores changes little, and it can prevent a rise of array disturbance of the carcass cord.

In the present invention, the tubular carcass with bead cores forming process on the first drum and the rubber laminate forming process on the second drum can be parallely taken. It can reduce process time and improve the formation efficiency of the green tire.

So-called a “strip-wind method” is proposed to form inner liner rubber, belt cushion rubber, chafer rubber, sidewall rubber and/or the like, for example, by winding the tape-like rubber strip spirally. In this method, there are problems that the air is apt to rest between the rubber strips and that detachment is apt to arise between the rubber strips. However, in the present invention, at the time of the above-mentioned jointing, the rubber laminate is diameter-expanded. Therefore, a tension power at the time of this diameter-expanding can exhaust the air between the rubber strips. And, it brings efficacies to enhance an adhesive force by the pressure bonding between the rubber strips and to inhibit the detachment. Therefore, the present invention can be preferable for the strip-wind method.

In particular, to form the inner liner rubber and the belt cushion rubber in the strip-wind method brings significant benefits. In the inner liner rubber, cohesion between the strips is more enhanced by the diameter-expanding of the second drum, and air-impermeant property can be enhanced more than traditional one that made by jointing sheet-like inner liner rubbers. Moreover, since the shape of the belt cushion rubber had a large influence on a ground contacting shape, conventionally it was necessary to prepare belt cushion rubbers having an optimal cross-sectional shape according to each tire type, and it was likely to decline its productivity. However, owing to forming the belt cushion rubber in the strip-wind method, the cross-sectional shape can be formed by changing winding-pitch and the like of the rubber strip depending on the each tire type, and the productivity can greatly increase.

A diameter-expanding ratio Db/Da of an outside diameter Db of the expanded second drum to an outside diameter Da before expanding thereof is preferably in a range of 1.025±0.01. Owing to limiting the diameter-expanding ratio within this range, the air inclusion can be prevented; and the strength of the rubber member, particularly the strip for example, can be improved moderately. And, the thinning of the rubber member caused by an excessive diameter-expanding can be prevented.

### BRIEF EXPLANATION OF THE DRAWING

FIG. 1 is a cross-sectional view showing an embodiment of a vulcanized pneumatic tire formed in the green tire forming method of the present invention.

FIG. 2 is a flowchart of the method for forming the green tire.

FIG. 3 is a process chart of the green tire forming method.

FIGS. 4(A) and (B) are a top view and a side view showing a winding stage in a tubular carcass forming step.

FIGS. 5(A) and (B) are a side view and its partially enlarged view showing a joining stage in a tubular carcass forming step.

FIG. 6 is a figure showing a joining step of bead cores.

FIG. 7(A) is a cross-sectional view showing a rubber laminate forming process, and FIG. 7(B) is a partial cross sectional view showing a strip winding step.

FIG. 8 is a side view of a transfer.

FIGS. 9(A) and (B) are cross-sectional views of an overwrap joint and a butt joint of the carcass ply member.

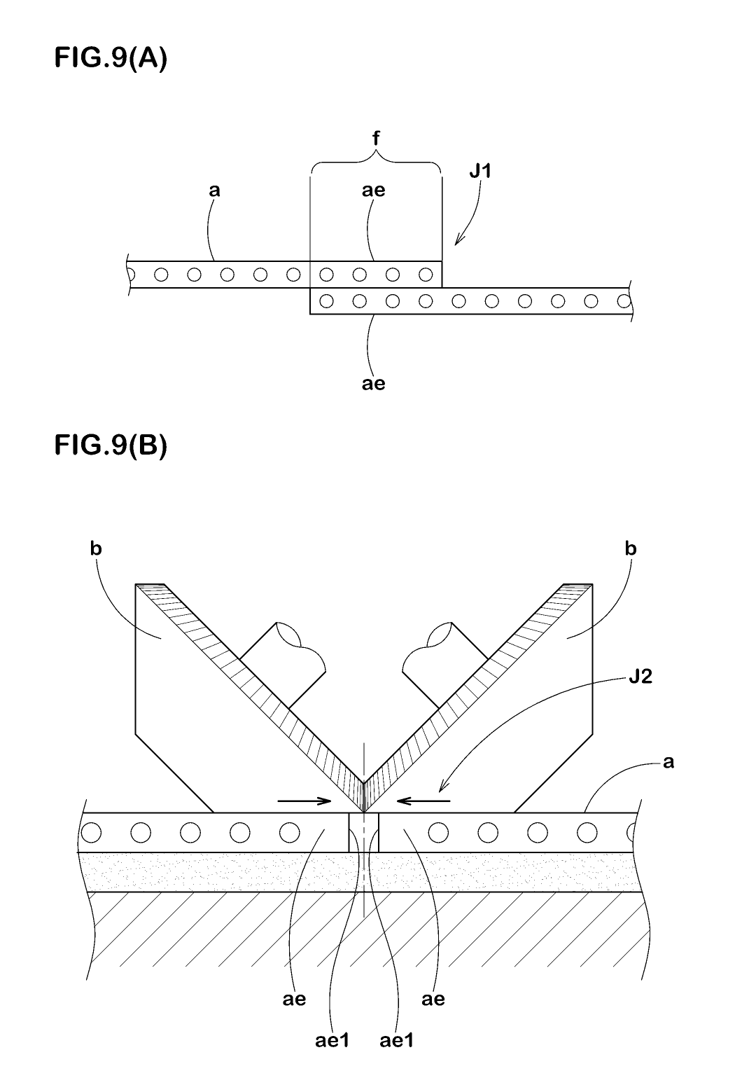

FIG. 10 is a cross-sectional view showing a jointing by use of a butt joint apparatus comprising a pair of conical bodies in respective over-and-under sides.

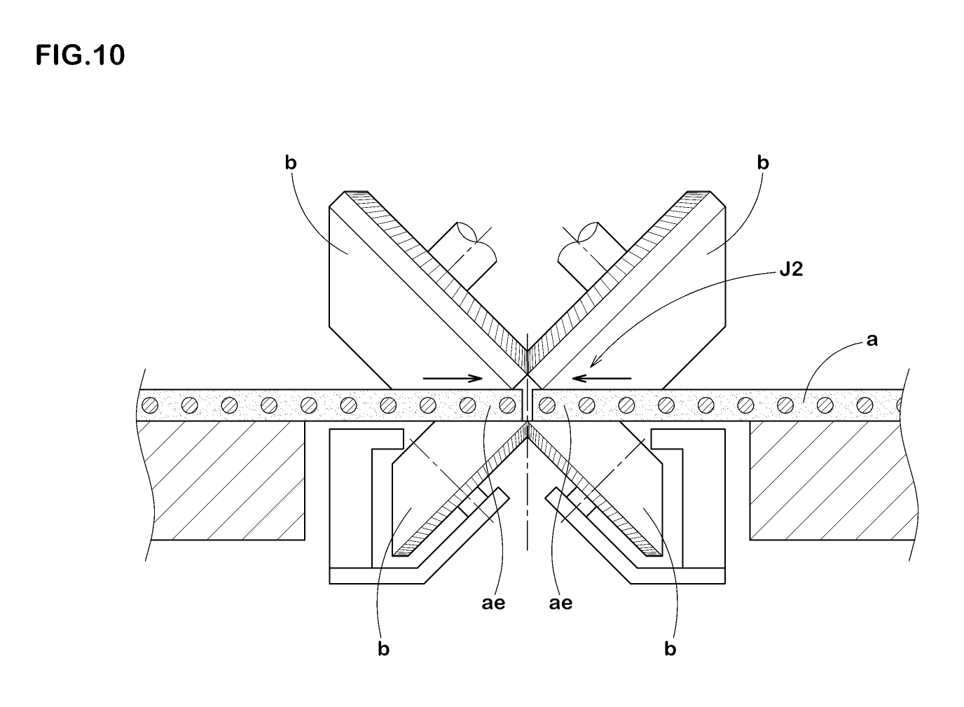

### EXPLANATION OF THE REFERENCE

5 Bead core
6R1 Carcass ply member
6R2 Tubular carcass
6R3 Tubular carcass with bead cores
11 Rubber laminate
20 First drum
27 Second drum
30 Transfer
35 Tubular base tire
36 Transfer
37 Shaping drum
Ga Base tire rubber member
G3a Sidewall rubber member
G4a Chafer rubber member
G10Ga Inner liner rubber member
J2 Butt joint
K1 Tubular carcass with bead cores forming process
K1a Tubular carcass forming step
K1b Joining step of bead cores
K2 Rubber laminate forming process
K2a Strip winding step
K3 First transport process
K4 Tubular base tire forming process
K5 Second transport process
T4, T3 Rubber strips

### BEST MODE FOR CARRYING OUT THE INVENTION

Hereinafter, an embodiment of the present invention will now be explained particularly.

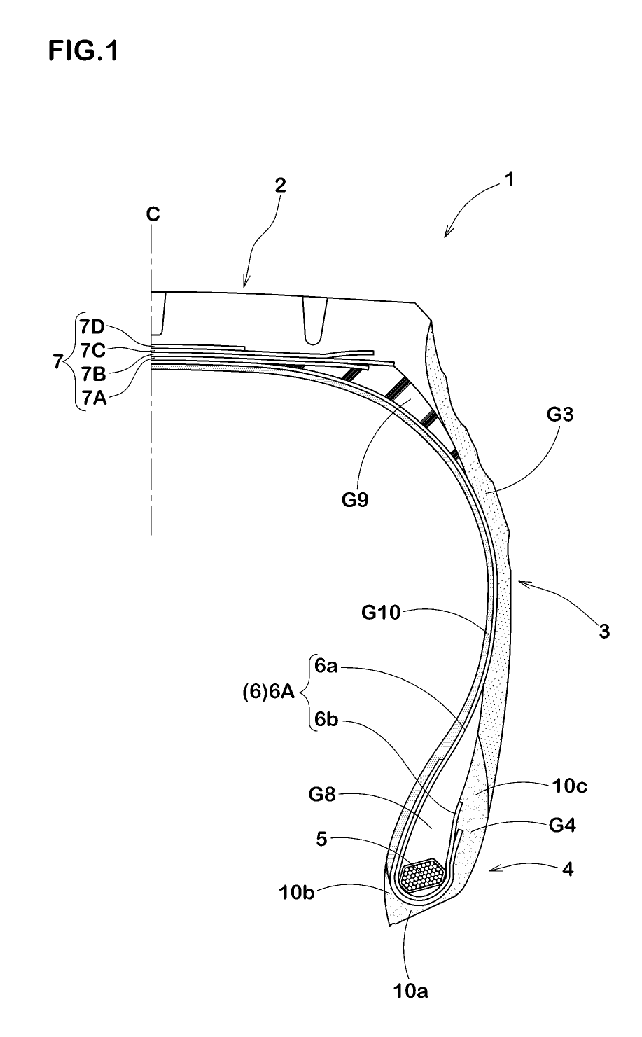

FIG. 1 is a cross-sectional view showing an embodiment of a vulcanized pneumatic tire formed in a green tire forming method of the present invention.

In FIG. 1, a pneumatic tire 1 of the present embodiment is a heavy-duty radial tire. The pneumatic tire 1 comprises at least a carcass 6 extending from a tread portion 2 to a bead core 5 of a bead portion 4 through a sidewall portion 3, and a tread reinforcing belt layer 7 disposed outside the carcass 6 in the radial direction of the tire in the tread portion 2.

The carcass 6 is formed by a single carcass ply 6A made of an arrangement body of carcass cords arranged at an angle of from 70 to 90 degrees with respect to the tire circumferential direction and coated with topping rubber. The carcass ply 6A comprises a toroidal-shaped ply main portion 6a extending between the bead cores 5, 5; and a pair of turned up portion 6b each of which is turned up and secured around each of the bead cores 5 from inside to outside. Between the ply main portion 6a and the turned up portion 6b, a bead apex rubber G8 is provided for bead reinforcement which extends from the bead core 5 outwardly in the radial direction in a tapered manner.

The belt layer 7 is formed by at least two belt plies made of an arrangement body of belt cords and coated with topping rubber. In the present embodiment, the belt plies comprise a first belt ply 7A disposed innermost in the tire radial direction and comprising the belt cords arranged at an angle of 60±15 degrees, for example, with respect to the tire circumferential direction, and second to fourth belt plies 7B, 7C, and 7D disposed gradually outwardly in the radial direction and comprising the belt cords arranged at a small angle of from 10 to 35 degrees, for example, with respect to the tire circumferential direction. The axially outer ends of the belt layer 7 are gradually apart from the carcass 6 according as the ends are located in axially outsider, and the separated portion thereof is provided with a belt cushion rubber G9 having a substantially triangle shape of a cross-section. The belt cushion rubber G9 is made of a comparatively soft rubber to follow the deformation of the outer end of the belt layer 7 during running under load, and inhibits a belt-end separation by absorption and distribution of its strain.

An inner liner rubber G10 is provided on the inside of the carcass 6 to form the tire cavity surface. A sidewall rubber G3 is provided on the outside of the carcass to form the outer surface of the sidewall portion 3. A chafer rubber G4 having a substantially U-shape of a cross-section is provided in the bead portion 4, which comprises a basal portion 10a forming a bead bottom, an inner portion 10b forming the inner surface of the bead portion 4 disposed in axially inner end of the basal portion 10a, and an outer portion 10c forming the outer surface of the bead portion 4 disposed in axially outer end of the basal piece 10a.

The inner liner rubber G10 is made of a rubber having air-impermeant property such as butyl rubber and halogenated butyl rubber, for example, and keeps airtightly the high-pressure air filled up in the tire cavity. The sidewall rubber G3 is made of a comparatively soft rubber having inflection resistance, ozon resistance, tearing resistance and the like. The sidewall rubber G3 follows the deformation of the carcass 6 and covers protectively the carcass 6 against injury. The chafer rubber G4 is made of a harder rubber than the sidewall rubber G3 and has the wear resistance and cut resistance, and prevents damages caused by shifting of the rim. The inner piece 10b and the outer piece 10c of the chafer rubber G4 are adjacent to the inner liner rubber G10 and the sidewall rubber G3, respectively.

The pneumatic tire 1 is made by vulcanizing an unvulcanised green tire in a vulcanization mold just like the traditional one, and the green tire is made in the following green tire forming method according to the present invention.

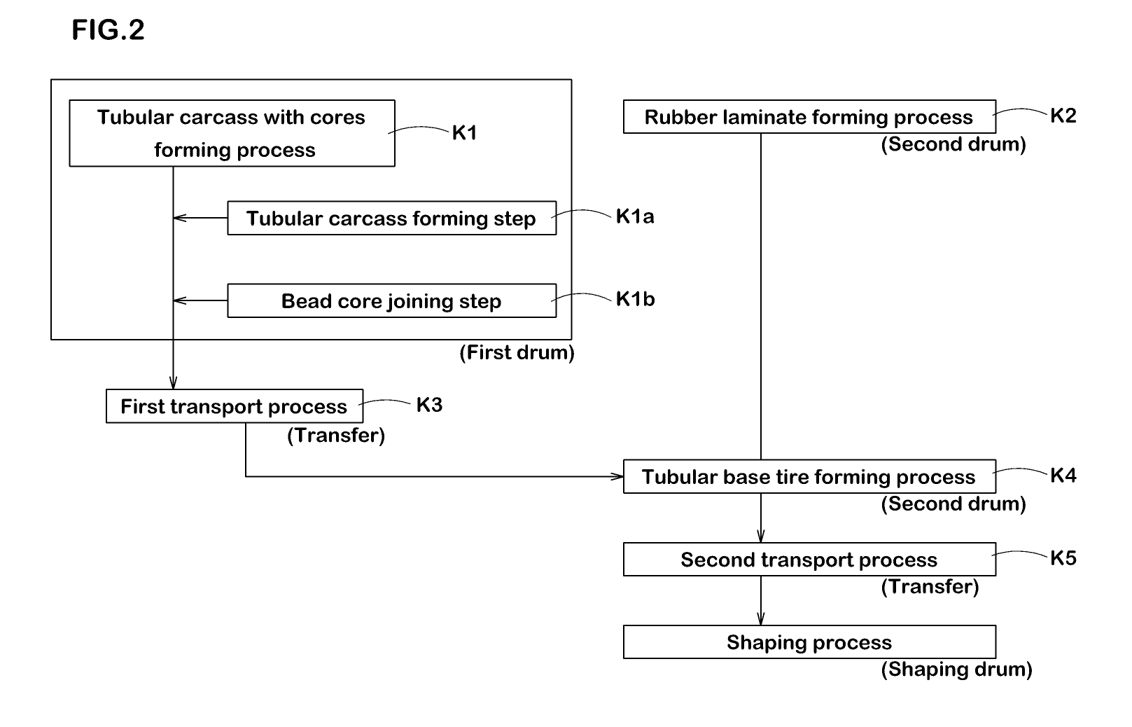

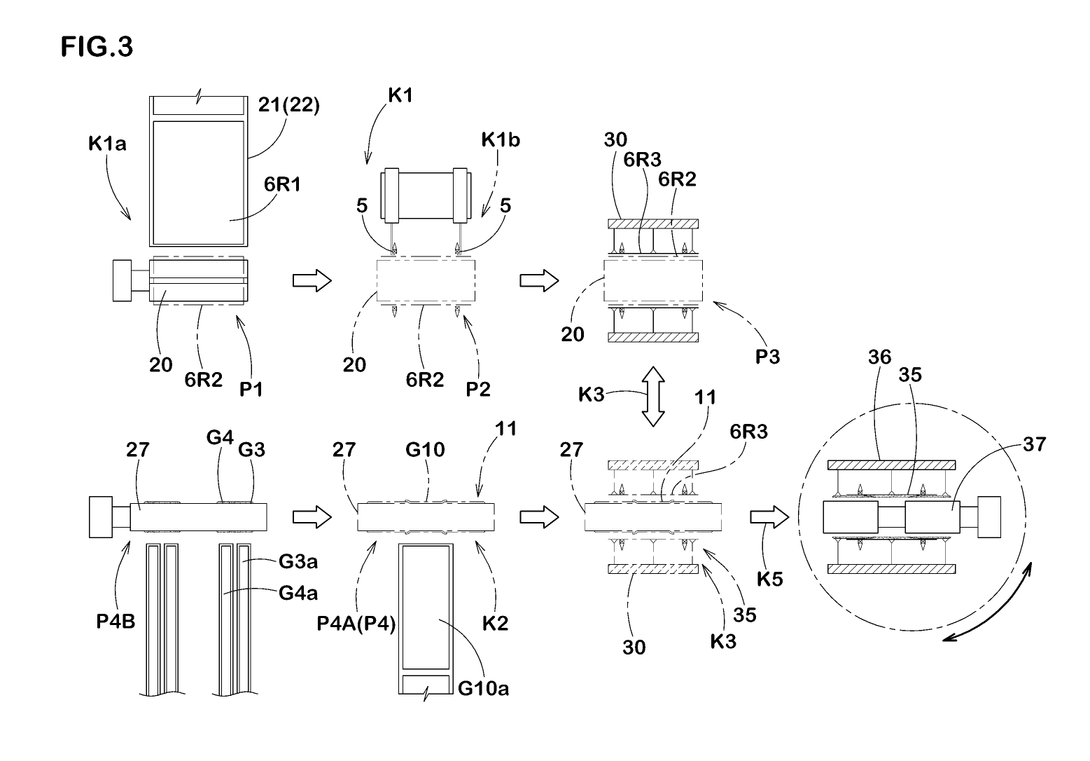

As shown in the flowchart of FIG. 2 and the process chart of FIG. 3, the green tire forming method comprises

a tubular carcass with bead cores forming process K1,

a rubber laminate forming process K2,

a first transport process K3,

a tubular base tire forming process K4, and

a second transport process K5.

The tubular carcass with bead cores forming process K1 comprises a tubular carcass forming step K1a and a bead core joining step K1b, and makes a tubular carcass with bead cores 6R2 on a first drum 20. The tubular carcass forming step K1a comprises

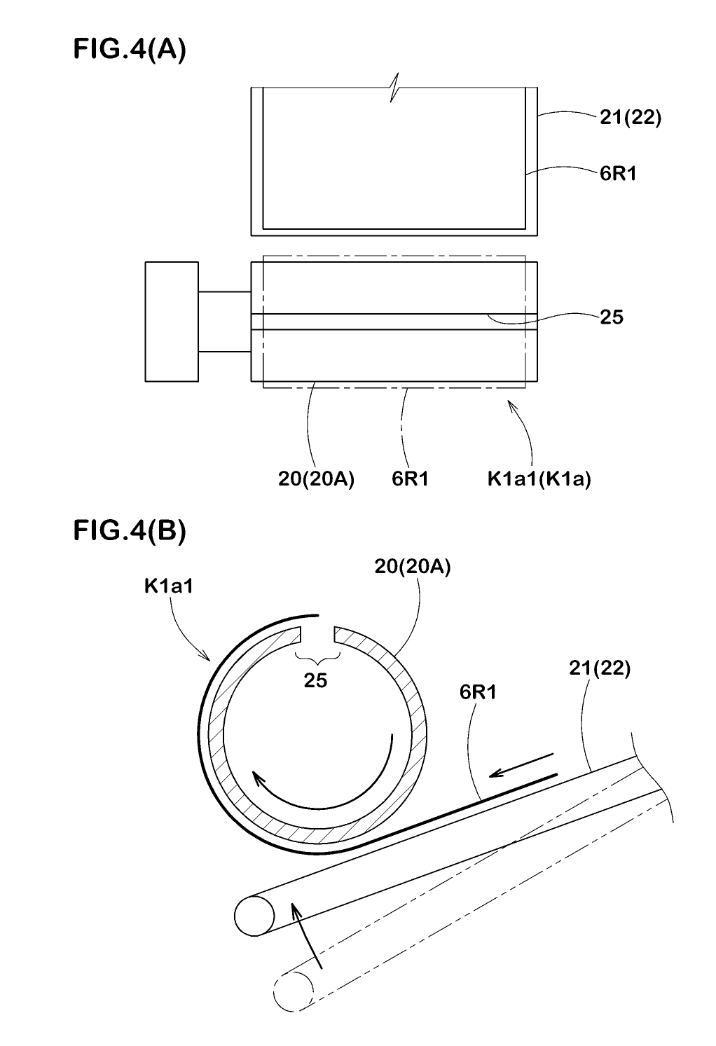

a winding stage K1a1 to wind a single layer of a sheet-like carcass ply member 6R1 for forming a carcass ply on its outer periphery by use of the first drum 20 as shown in FIG. 4, and

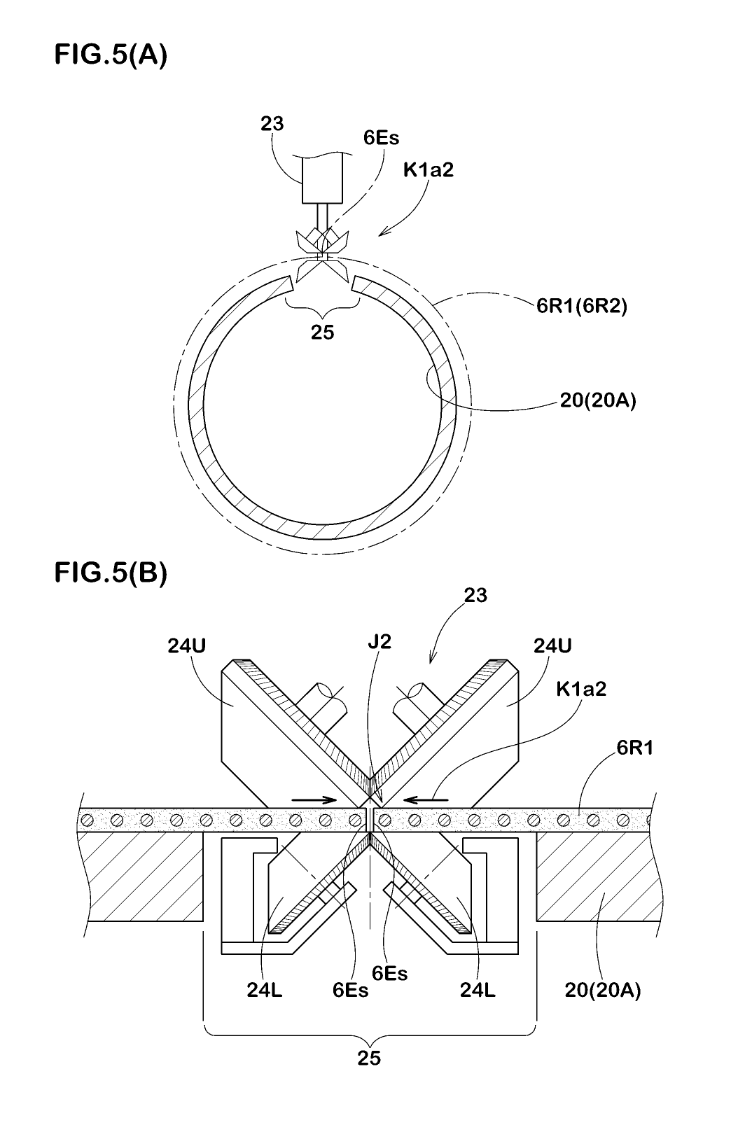

a butt-jointing stage K1a2 to butt-joint the circumferential end faces 6Es of the single layer of the carcass ply member 6R1 wound as mentioned above by facing each other, as shown in FIG. 5.

More particularly, in the winding stage k1a1, the carcass ply member 6R1 supplied from a ply servicer 22 by use of the belt conveyor 21 is pushed onto the outer periphery of the first drum 20 so as to wind as a single layer of the carcass ply member 6R1 while rotating this first drum 20. The belt conveyor 21 of the present embodiment is pivotally supported freely in tilting over-and-under with setting its upper stream side in the conveyance direction as a supporting point, and the conveyance surface is pushed from the downstream onto the first drum 20 so as to wind the carcass ply member 6R1 while being pushed onto the drum 20.

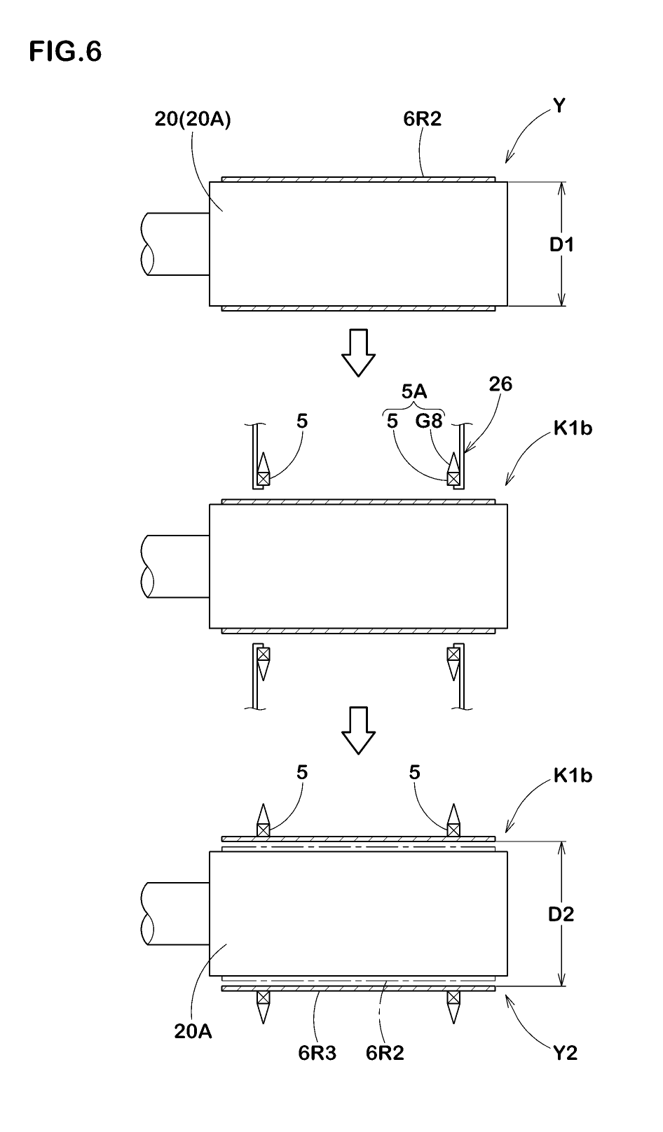

Incidentally, the first drum 20 comprises a drum portion 20A having a straight cylinder shape. As shown in FIG. 6, in a well-known scalable diameter method, the diameter of the drum portion 20A is scalable between a diameter D1 at a reference state Y1 and a diameter D2 at a diameter-expanded state Y2. The reference state Y1 is defined as a state of winding at least a single layer of the above-mentioned carcass ply member 6R1. The expanded diameter state Y2 is defined as a state of joining by pressing the carcass ply member 6R1 against the inner periphery of the bead core 5 disposed outwardly in the radial direction of the carcass ply member 6R1. The above-mentioned drum portion 20A is provided with a cutout 25 (shown in FIG. 4) through which a conical body 24 and the like of a joint apparatus 23 passes is formed overall length in the direction of the shaft center of the drum.

As shown in FIG. 5, in the above-mentioned butt-jointing stage K1a2, by use of the well-known joint apparatus 23, the circumferential end faces 6Es and 6Es of the carcass ply member 6R1 are butt-jointed so as to form the tubular carcass 6R2 continuing in the circumferential direction. The joint apparatus 23 of the present embodiment comprises a pair of upper conical bodies 24U, 24U disposed outward in the radial direction, and a pair of lower conical bodies 24L, 24L disposed inward in the radial direction. The carcass ply member 6R1 is sandwiched from both inward-and-outward in the tire radial direction and is drawn respective end parts so as to face each other by a powerful force, and the joint strength can be increased. Incidentally, a preferably example of the joint apparatus 23 to be used is shown in Japanese unexamined Patent Application Publication No. 2007-320196.

In the bead core joining step K1b, as shown in FIG. 6, after putting the bead core 5 on the axially both sides of the tubular carcass 6R2 and on the radially outer side, the first drum 20 is expanded in a siameter with the tubular carcass 6R2. Therefore, a tubular carcass with bead cores 6R3 is formed by pressing the tubular carcass 6R2 against the inner periphery of the bead core 5 and integrally joining. Moreover, since the carcass ply member 6R1 is wound on the straightly cylindrical first drum 20 directly, and is joined to the bead cores while keeping its straightly cylindrical shape to by diameter-expanding with this drum 20, an arrangement of the carcass cords under the bead core 5 and a carcass cord path between the bead cores 5, 5 can be maintained uniformly. The bead core 5 is supplied onto the tubular carcass 6R2 by use of the traditional well-known bead core supply device 26. Incidentally, an example of the bead core 5 to be used is a bead core assembly 5A can be used, which is provided on its outer periphery with the bead apex rubber G8 integrally jointed, as shown in the present embodiment.

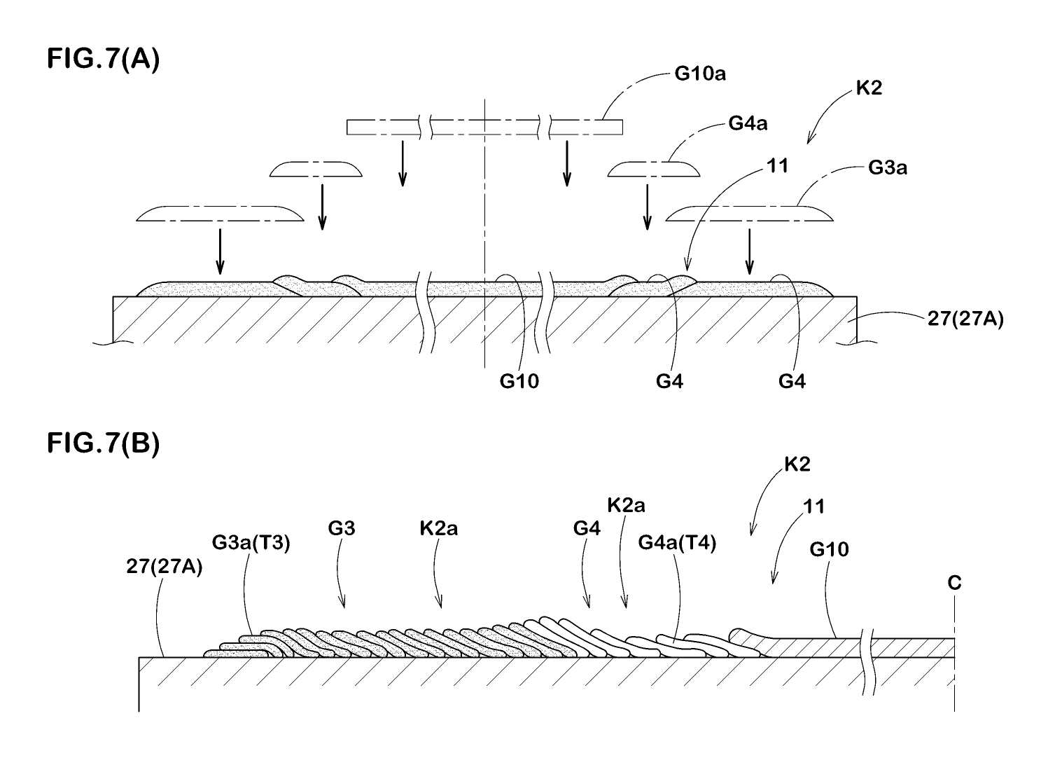

In the rubber laminate forming process K2, as shown in FIG. 7 (A), rubber members for base tire Ga including an inner liner rubber member G10a for forming the inner liner rubber G10 are gradually wound on its outer periphery of the second drum 27 so as to form the cylindrical rubber laminate 11 having a smaller outside diameter than an inside diameter of the above-mentioned tubular carcass 6R2. The second drum 27 comprises a scalable and straightly-cylindrical drum portion 27A as the same as the above-mentioned first drum 20.

As mentioned above, the base tire means a green tire body on which no tread portion has been formed. The above-mentioned rubber member for base tire Ga means a rubber member to form this base tire. The rubber member for base tire Ga comprises a chafer rubber member G4a for forming the above-mentioned chafer rubber G4 and a sidewall rubber member G3a for forming the sidewall rubber G3 besides the inner liner rubber member G10a.

In the present embodiment, as shown in FIG. 7(B), the chafer rubber member G4a and the sidewall rubber member G3a are formed of tape-like long rubber strips T4, T3, respectively. The forming process of rubber laminate K2 comprises a strip winding step K2a to wind spirally each of the rubber strips T4, T3. More particularly, the rubber strips T3, T4 are wound gradually and spirally on the above-mentioned drum part 27A so as to form a layer of the sidewall rubber G3 and a layer of the chafer rubber G4. Between the chafer rubbers G4, G4, there is a layer of the inner liner rubber G10 formed by wrapping a single layer of the sheet-like inner liner rubber member G10a in the present embodiment. Incidentally, it comes near to stating the obvious that also the inner liner rubber G10 may be formed by spirally winding the rubber strip (not shown).

When providing on the tire with a cord reinforcing ply (not shown) for reinforcement of the bead portion and with a cord reinforcing ply (not shown) for reinforcement of the sidewall portion, for example, a layer of the cord reinforcing ply may be formed on the rubber laminate 11 by winding the member for forming the cord reinforcing ply in this forming process of rubber laminate K2.

In the first transport process K3, by use of a transfer 30, the above-mentioned tubular carcass with bead cores 6R3 is transferred from the first drum 20 to the second drum 27, and concentrically maintained radially-outside the rubber laminate 11 on the second drum 27.

In the present embodiment, as shown in FIG. 3, the first drum 20 is reciprocatably movable from a supplying position of carcass ply P1 through a supplying position of bead core to a supplying position of tubular carcass P3. The second drum 27 is also reciprocatably movable from a supplying position of base tire rubber P4 to a receiving position of tubular carcass P5. In the present embodiment, the supplying position of base tire rubber P4 comprises a supplying position of first base tire rubber P4A to supply the inner liner rubber member G10a; and a supplying position of second base tire rubber P4B to supply other base tire rubber members Ga comprising the sidewall rubber member G3a and the chafer rubber member G4a. Either of the supply point P4A or the supply point P4B may be formed on the upper stream in the conveyance direction. The above-mentioned transfer 30 is reciprocatably movable between the supplying position of tubular carcass P3 and the receiving position of tubular carcass P5. The tubular carcass with bead cores 6R3 received from the first drum 20 is transferred to the receiving position of tubular carcass P5, and concentrically maintained radially-outside the rubber laminate 11 at this point P5.

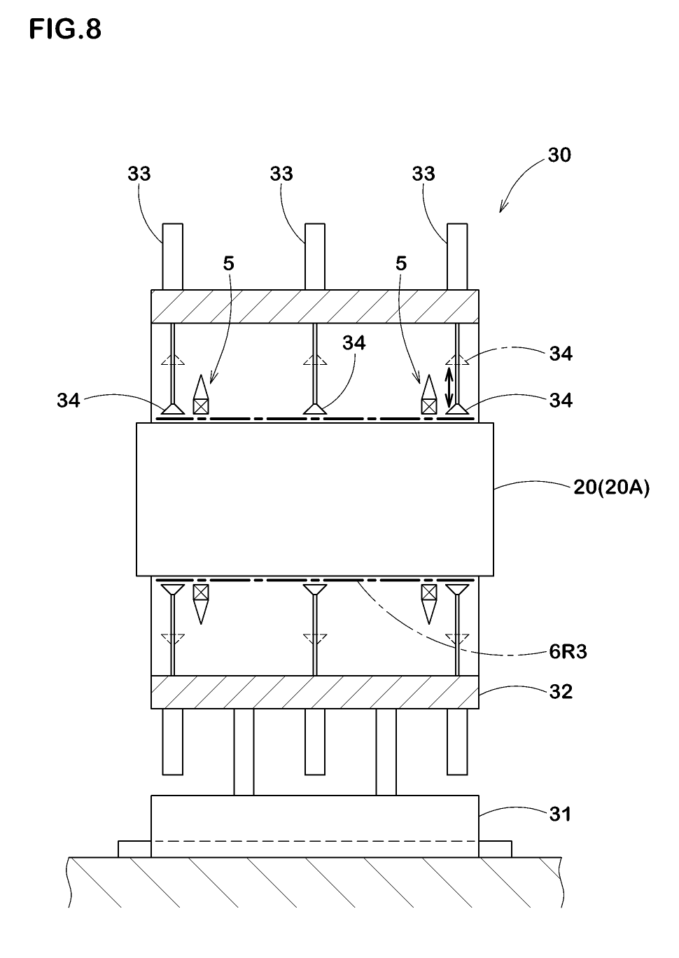

As shown conceptually in FIG. 8, in the present embodiment the transfer 30 comprises

a movable pedestal 31 which is reciprocatable between the supplying position of tubular carcass P3 and the receiving position of tubular carcass P5, and an annular supporting frame 32 attached to the movable pedestal 31 and being possibly the same concentric as the first drum 20 and the second drum 27 at the positions P3, P5. And, in the both axial sides of the supporting frame 32, the both axial sides and a central region in the present embodiment, a plurality of cylinders 33 are spaced at an interval in the circumferential direction, of which rod end is headed for the shaft center of the supporting frame 32. The each rod end is provided with a suction appliance 34 such as a vacuum pad and the like, for example. Therefore, the transfer 30 at the state of outserting the first drum 20, by stretching the cylinder 33, the suction appliance 34 sucks and keeps the outer periphery and axial both sides of the tubular carcass with bead cores 6R3 on the first drum 20. And after that, owing to the diameter reduction of the first drum 20, the tubular carcass with bead core 6R3 can be received from the first drum 20. At the position P5, the transfer 30 can concentrically maintain the tubular carcass with bead core 6R3 radially-outside the rubber laminate 11.

In the tubular base tire forming process K4, at the state of maintaining the tubular carcass with bead core 6R3 concentrically, the second drum 27 is diameter-expanded with the rubber laminate 11. Therefore, the rubber laminate 11 can be pressed against the inner periphery of the tubular carcass with bead cores 6R3 in the outside thereof, and a tubular base tire 35 formed by jointing integrally the rubber laminate 11 with the tubular carcass with bead cores 6R3. When turning off the vacuum and shrinking the rod of the cylinder 33, the transfer 30 releases the tubular base tire 35 and returns to the above-mentioned supplying position of tubular carcass P3.

A diameter-expanding ratio Db/Da of an outside diameter Db of the expanded second drum 27 to an outside diameter Da before expanding thereof is preferably in a range of 1.025 plus/minus 0.01. Owing to the limitation of the diameter-expanding ratio within the range, it can be prevented to include the air and to improve moderately the strength of the rubber member such as the inner liner rubber and the sidewall rubber (especially, a strip), for example. Moreover, it can also prevent from the enormous thinning of the rubber member caused by an excessive diameter-expanding.

In the present embodiment, when the tire 1 comprises the above-mentioned belt cushion rubber G9, the tubular base tire 35 on the second drum 27, which is released from the transfer 30, returns once to the supplying position of tire rubber P4 (for example, the supplying position of second base tire rubber P4B); and at this supply position P4, the belt cushion rubber member (not shown) for forming the belt cushion rubber G9 is wound on the tubular carcass 6R3. Such a belt cushion rubber G9 is also preferably formed by winding spirally the unvulcanised rubber strip. The belt cushion rubber G9 has a large impact on the ground contacting shape depending on shapes; therefore, under ordinary circumstances, it is necessary to prepare an optimal cross sectional shape according to tire type. However, by forming the belt cushion rubber G9 in the strip-wind method, the cross sectional shape can be optimize according to tire type in each case by changing the winding pitch and the like so as to make remarkable progress in production efficiency. Moreover, in the above-mentioned bead core joining step K1b, when the bead core 5 is used in place of the above-mentioned bead core assembly 5A, the bead apex rubber member (not shown) for forming the bead apex rubber G8 is wound on the outer periphery of the bead core 5 in this stage.

After that, the tubular base tire 35 with the belt cushion rubber G9 and the like is transported in a second transport process K5 having the same composition as the transfer 30, to the shaping drum 37 after receiving at the receiving position of tubular carcass P5 from the second drum 27 and is mounted on the shaping drum 37.

An example of this shaping drum 37 to be used is a traditional well-known shaping drum. On a conventional shaping process, the transported tubular base tire 35 is inflated so as to have a toroidal shape between the bead cores 5, 5; the inflated portion is pressed against the inner periphery of the tread ring previously awaiting outside in the radial direction; and the toroidal green tire is formed by jointing integrally. And, the shaped green tire is vulcanized so as to accomplish the pneumatic tire.

In this way, in the green tire forming method of the present invention, since the carcass ply member 6R1 is wound on a different drum from the inner liner rubber member G10a, the carcass ply member 6R1 can be butt-jointed solidly without being distracted by the inner liner rubber member G10a. In the present invention, the tubular carcass with bead cores forming process K1 on the first drum 20 can be conducted on a parallel with the rubber laminate forming process K2 on the second drum 27, and it can save the time and improve forming-efficiency of the green tire.

In the process K1, the carcass ply member 6R1 is wound directly on the straightly cylindrical first drum 20, and it is diameter-expanded while keeping the shape of the straight cylinder and jointed with the bead cores 5. Therefore, the arrangement of the carcass cords under the bead core 5 and the carcass cord path between the bead cores 5, 5 can be maintained uniformly.

Moreover, since the tubular carcass with bead cores 6R3 and the rubber laminate 11 separately formed are integrally jointed each other by the diameter-expanding of the second drum 27 while keeping the straight cylinder shapes, the tubular base tire 35 can be formed easily, with high accuracy and efficiently without using any complex apparatus. At the time of jointing, the rubber laminate 11 is diameter-expanded. Therefore, when the rubber laminate 11 comprises a layer of the rubber member in the strip-wind method, a tension power of this diameter-expanding discharges the air between the rubber strips. The pressure bonding of the tension power acting between the rubber strips and the adhesive property is enhanced, and the separation between the rubber strips can be inhibited.

Although the especially preferred embodiments of the pneumatic tire and the method for manufacturing it in the present invention have been described in detail, needless to say, the invention is not limited to the above-mentioned concrete embodiments, and various modifications can be made.

### EXAMPLE

Heavy duty radial tires having tire sizes of 11R22.5 were made in accordance with the method of the present invention (Examples), and various properties were tested. A tire having a carcass ply overwrap-jointed (comparative Example) was also tested in the same manner. Test methods were as follows.

### [Test 1 (Test for Air-Permeability of Inner Liner)]

The test tire was inflated at an air pressure of 700 kPa, the air pressure was measured after running 100,000 km on a drum under the following condition. The test result was displayed using indices with the air pressure of Comparative Example 1 being 100. The larger the numeric value was, the smaller the air leakage was; and the more favorable it was.

Rim: 7.50×22.5

Tire load: 26.7 kN

velocity: 80 km/H

### [Test 2 (Test for Air Inclusion While Forming Tire)]

One hundred tires were vulcanized and each tire was examined whether any air-inclusion are included using sialography method that can judge the presence of air-inclusion by interference fringe in a vacuum circumstance. The evaluation was displayed using indices on percentage of “the number of tire including the air/100”. The smaller the numeric value was, the more favorable it was. The test result was shown in Table 1.

TABLE 1

| | Ref. | | | | | | |
|---|---|---|---|---|---|---|---|
| | Example | Example 1 | Example 2 | Example 3 | Example 4 | Example 5 | Example 6 |
| Forming of inner liner | SJT | STW | STW | STW | STW | STW | SJT |
| Forming of belt cushion | SJT | STW | STW | STW | STW | STW | SJT |
| rubber | | | | | | | |
| Forming of chafer rubber | SJT | STW | STW | STW | STW | STW | STW |
| Forming of sidewall rubber | SJT | STW | STW | STW | STW | STW | STW |
| Diameter-expanding ratio | — | 1.025 | 1.033 | 1.017 | 1.04 | 1.008 | 1.025 |
| Test 1 [Index] | 100 | 104 | 103 | 104 | 101 | 103 | 103 |
| Test 2 [%] | 1 | 0 | 0 | 0 | 0 | 1 | 0 |

SJT: Jointing of a single sheet;
STW: Strip-wind method

For the test result, it was confirmed that Examples excelled in the result of the tests 1 and 2.

1. A green tire forming method comprising
a tubular carcass with cores forming process to form a tubular carcass with bead cores on a first drum, which comprising
a tubular carcass forming step comprising
winding a sheet-like carcass ply member on an outer periphery of the first drum in a single layer, and
butt-jointing each circumferential end face of the carcass ply member each other, and
a bead core joining step comprising
putting a pair of bead cores on radially outwardly and axially both end sides of the tubular carcass on the first drum, and
expanding a diameter of the first drum with the tubular carcass so that the tubular carcass is pressed against an inner periphery of bead cores and firmly jointed thereto;
a rubber laminate forming process to form a cylindrical rubber laminate having a smaller outside diameter than an inside diameter of said tubular carcass by winding rubber members for a base tire including an inner liner rubber member on an outer periphery of a second drum which is expandable in a diameter;
a first transport process to transport said tubular carcass with bead cores from said first drum to the second drum by use of a transfer, and to maintain concentrically the tubular carcass with bead cores radially-outside the rubber laminate on the second drum;
a tubular base tire forming process by expanding the outside diameter of the second drum with the rubber laminate so that the rubber laminate is pressed against the inner periphery of said tubular carcass with bead cores so as to form a tubular base tire formed by jointing integrally said rubber laminate with the tubular carcass with bead cores; and
a second transport process to transport said tubular base tire from said second drum to a shaping drum by use of a transfer.

2. The green tire forming method as set forth in claim 1, wherein said base tire rubber member comprises at least a chafer rubber member and a sidewall rubber member; a tape-like long rubber strip is used for each of the chafer rubber member and the sidewall rubber member; and said lamination forming process comprises a strip winding step to spirally wind each of said rubber strips.

3. The green tire forming method as set forth in claim 1 or 2, wherein a tape-like long rubber strip is used for said inner liner rubber, and said lamination forming process of comprises a strip winding step to spirally wind each of said rubber strips.

4. The green tire forming method as set forth in claim 1, wherein the method comprises a forming step to form a belt cushion rubber by winding spirally a tape-like long rubber strip outside said carcass ply.

5. The green tire forming method as set forth in claim 1, wherein a diameter-expanding ratio Db/Da of an outside diameter Db of the expanded second drum to an outside diameter Da before diameter-expanding thereof is in a range of 1.025 plus/minus 0.01.

6. The green tire forming method as set forth in claim 1, wherein in said forming step of tubular carcass, circumferential end faces of said carcass ply member are butt jointed each other from both inward-and-outward in the tire radial direction.

7. A pneumatic tire producing method by use of the tubular base tire obtained in the green tire forming method as set forth in claim 1, wherein
the pneumatic tire producing method comprises
a toroidal green tire forming step comprising
inflating the tubular base tire between the bead cores to have a toroidal shape, and
pressing the inflated portion against the inner periphery of the tread ring previously awaiting outside in the radial direction and by jointing integrally, and
a green tire vulcanizing step.
